(19) United States
(12) Patent Application Publication
(10) Pub. No.: US 2006/0136079 A1
(43) Pub. Date: Jun. 22, 2006

(54) Method for organizing tournaments

(76) Inventor: Max Stern, Las Vegas, NV (US)

Correspondence Address: Jeffrey C. Maynard, 154 Barbara Road, Severna Park, MD, 21146, US

(21) Appl. No.: 11/090,809

(22) Filed: Mar. 26, 2005

Related U.S. Application Data
(60) Provisional application No. 60/637,178, filed on Dec. 17, 2004.

(51) Int. Cl. G06F 19/00; G06F 17/00

(52) U.S. Cl. 700/91

(57) ABSTRACT

Concepts for a method for conducting gambling tournaments for large numbers of participants are disclosed. The total number of participants is divided into groups of “N” players each. Each table will have “X” players. Of the “N” number of players per group, only a certain number of the last players of each group advance to the next grouping until arriving at a final table of “x” players. The winners from each group will share a portion of the prize pool.

### CROSS REFERENCE TO RELATED APPLICATION

This Application claims the benefit of U.S. Provisional Application Ser. No. 60/637,178 entitled Method for Organizing Tournaments, filed with the U.S. Patent and Trademark Office on Dec. 17, 2004.

### BACKGROUND OF THE INVENTION

1. Field of the Invention

The present invention relates to gambling games, and in particular, the invention provides a new and improved method for conducting tournaments for a plurality of players.

2. Background of the Prior Art

The popularity of gambling games, particularly poker, through televised broadcasts of poker tournaments has recently increased dramatically. Until a few years ago, poker tournaments were typically played with between 100 and 200 players, maximum. With recent successes of inexperienced players winning very large payouts, more people are encouraged to participate in such tournaments resulting in a massive influx of participants in various tournaments.

With the large influx of players, the dynamics and mathematical mechanics of such tournaments tend to change from a game of skill to a game of chance. In a tournament with 200 participants, a specific player has to cross a “bridge” (odds 52-48) four to five times. However, in a tournament with 5000 participants, that player will be forced to cross that “bridge” a minimum of twenty times. Therefore, even the best players will be exposed to the ‘flip-of-a-coin’ (chance) twenty times. This affects all players in general.

A need exists for a method to conduct gambling tournaments that can accommodate more players, that is simple to administer, and that results in increased opportunity for winning by the players and increased revenues for the game operator.

### SUMMARY OF THE INVENTION

Primary objects of the present invention are to provide tournament concepts and method steps for administering a gambling tournament.

One of the advantages of the present invention is to decrease the space required to conduct a tournament for larger numbers of contestants. For example, a tournament can be conducted at several venues of a hundred players or more instead of requiring a single venue for five thousand players.

Another advantage of the present invention is to divide the total number of players into a series of subgroups so that subsequent groups will consist of the top performers from the lower groups. In this manner, a participant who will eventually win the tournament must beat 250 players instead of 5000 players. Therefore, the tournament becomes more of a game of skill than of luck.

A further advantage is to enable growth capability. By creating groups of only 100 players, the tournament is less limited by the size of the space available to conduct the tournament. Tournaments can accommodate thousands of players that would be easily lodged in smaller areas instead of requiring one large space for all players at one time. Additionally, due to the group divisions, a tournament can be conducted over several dates without departing from the grouping concepts disclosed herein.

According to a first aspect, the present invention provides a method for conducting gambling tournaments for large numbers of participants. For example, with five thousand (5,000) players, the total number of participants is divided into groups of “N” players each. For example, each group can be made of 100 players. Larger or smaller groups can be used. Each table will have “X” players, such as 10 players, although other numbers of players can be used. Of the “N” number of players per group, only a certain number of the last players of each group will advance to the next grouping until arriving at a final table of “x” players. The winners from each group will share at least a portion of the prize pool.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIGS. 1a-1c illustrate the division of groupings for a field of 200 players;

FIGS. 2a-2c illustrate the division of groupings for a field of 360 players;

FIGS. 3a-3c illustrate the division of groupings for a field of 400 players;

FIGS. 4a-4c illustrate the division of groupings for a field of 500 players;

FIGS. 5a-5c illustrate the division of groupings for a field of 600 players;

FIGS. 6a-6c illustrate the division of groupings for a field of 1000 players; and

FIGS. 7a-7d illustrate the division of groupings for a field of 5000 players.

### DETAILED DESCRIPTION OF THE INVENTION

The invention summarized above and defined by the enumerated claims may be better understood by referring to the following detailed description, which should be read in conjunction with the accompanying drawings. This detailed description of an embodiment, set out below to enable one to build and use an implementation of the invention, is not intended to limit the invention, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

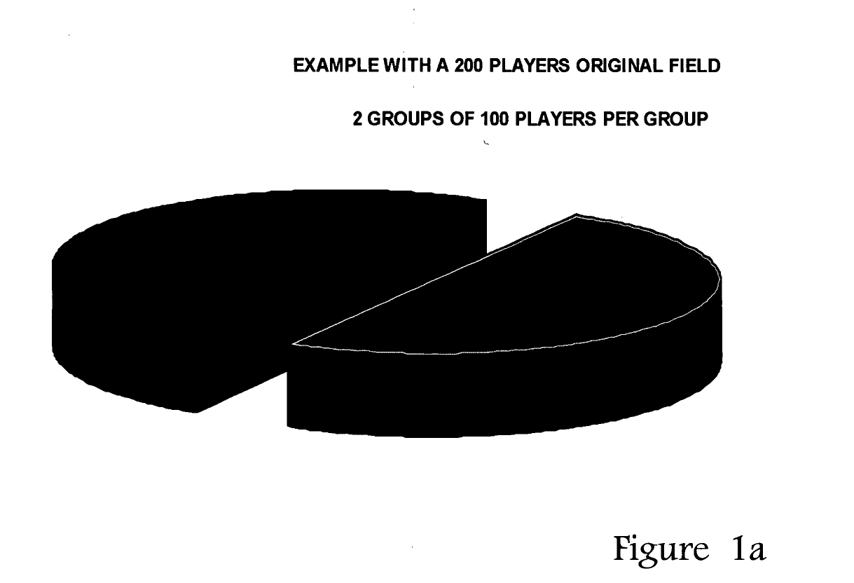

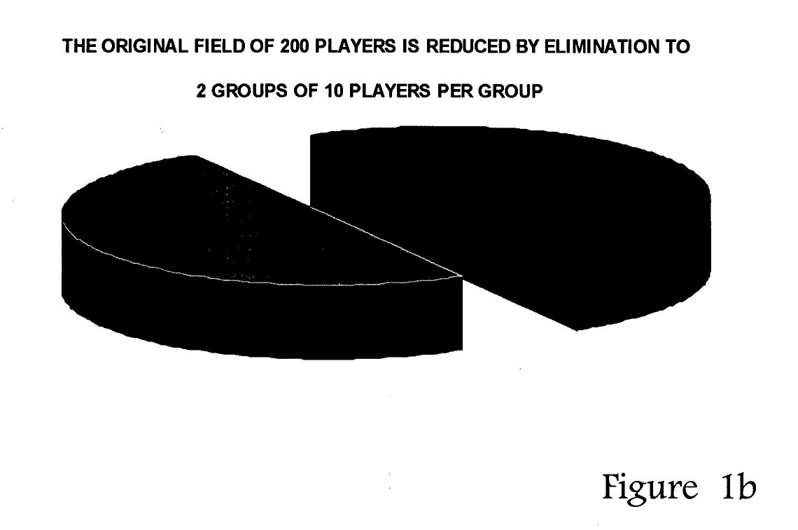

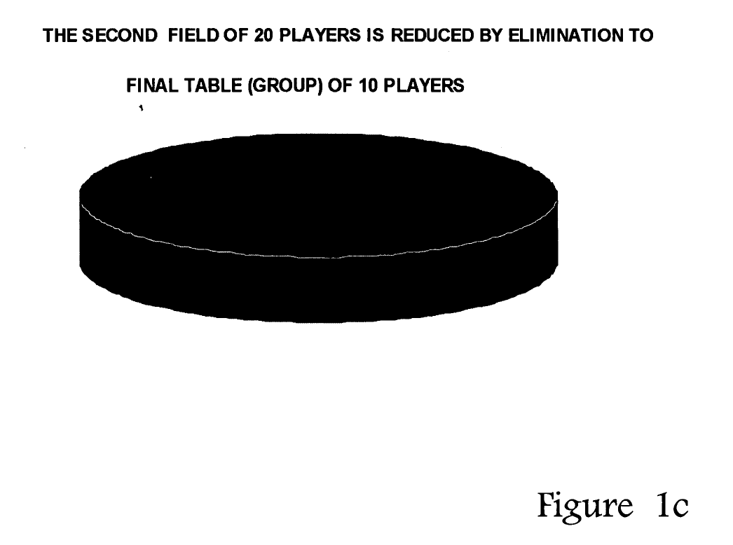

Referring to FIGS. 1a-1c, a tournament having 200 players in the original field is divided into two groups of 100 players, as shown in FIG. 1a, which can be ten tables of ten players each. Tournament play is conducted at each table. As players lose all their chips, they are eliminated. The original field of 200 players is reduced by elimination to two groups of 10 players per group, as shown in FIG. 1b. The last ten players of each group of 100 will share 20 percent of the total prize pool. The second field of 20 players is reduced by elimination to a final table of 10 players. The last five players of each 10-player group will share 30 percent of the total prize pool. FIG. 1c shows the final table of 10 players resulting from the second field of 20 players. All the players at the final table will receive a portion of the remainder of the prize pool in proportion to their final standing and as determined by the organizer of the tournament. Typically, this will be fifty percent of the prize pool.

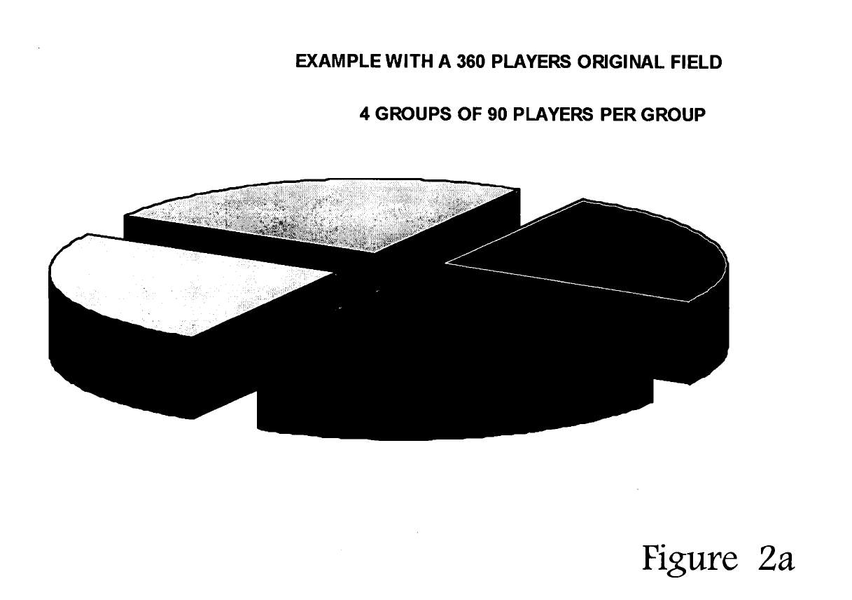

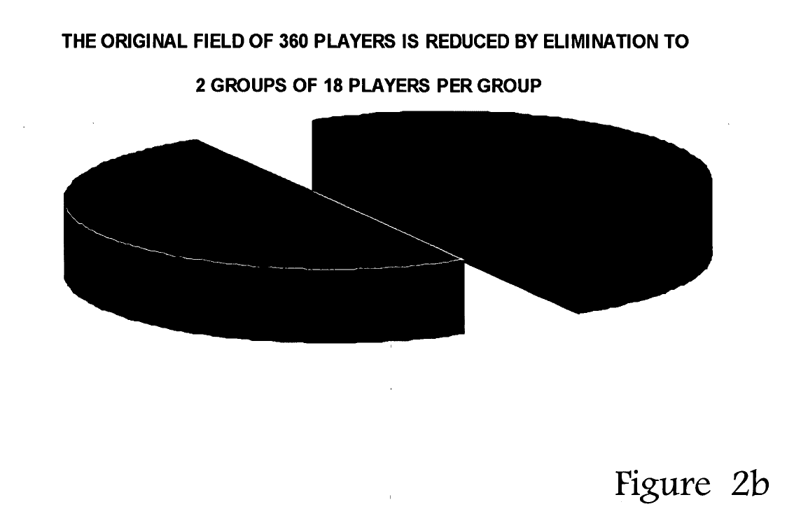

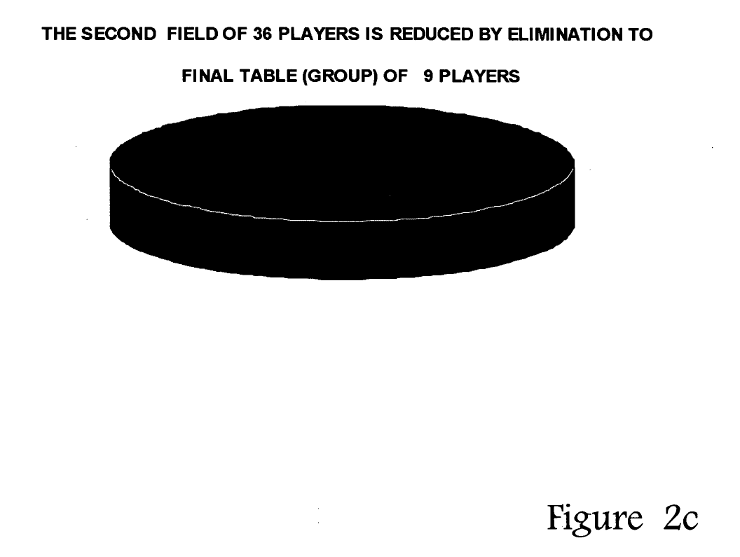

FIGS. 2a-2c illustrate a tournament having 360 players in the original field. The field is initially divided into four groups of 90 players, as shown in FIG. 2a, which can be ten tables of nine players each or nine tables of ten players each. The original field of 360 players is reduced by elimination to 36 players, and the last ten players of each group of 90 will share 20 percent of the total prize pool. The remaining field of 36 players is then divided into two groups of 18 players per group, as shown in FIG. 2b. The last nine players of the remaining two groups will share 30 percent of the total prize pool. FIG. 2c shows the final table of nine players resulting from the second field of 36 players. All the players at the final table will receive a portion of the remainder of the prize pool in proportion to their final standing and as determined by the organizer of the tournament. Typically, this will be fifty percent of the prize pool.

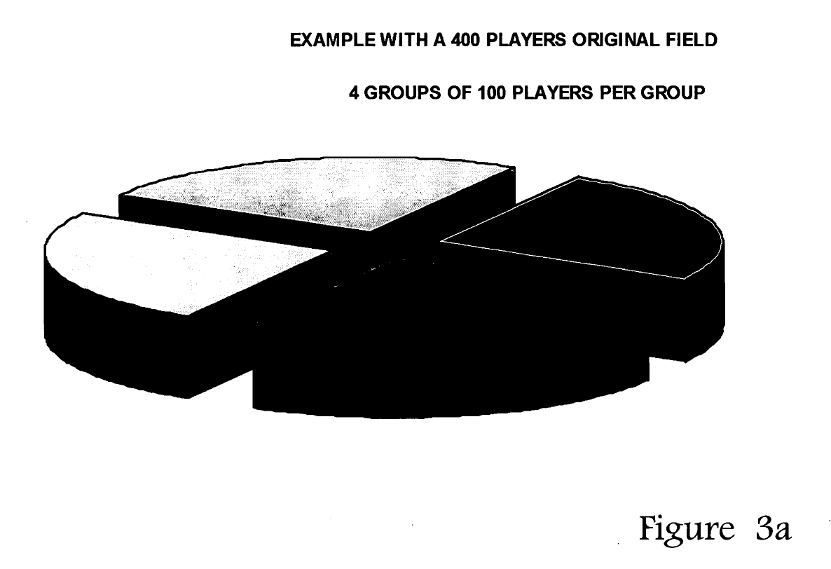

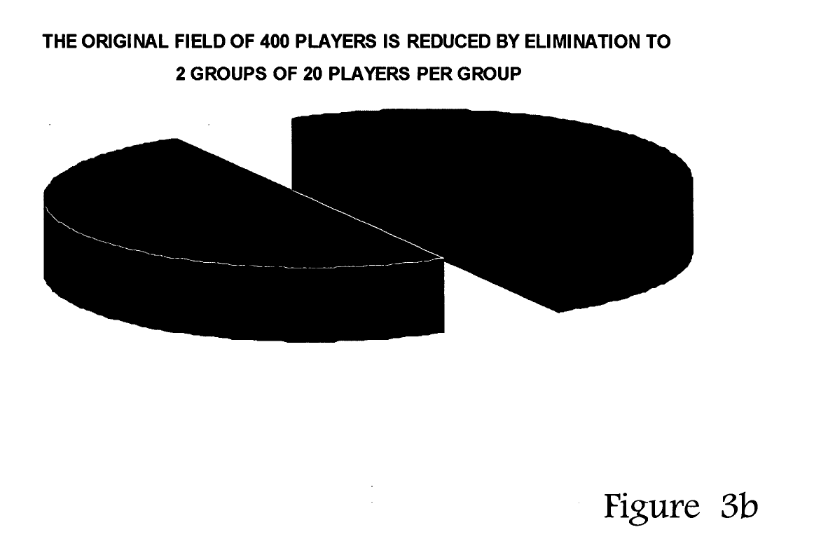

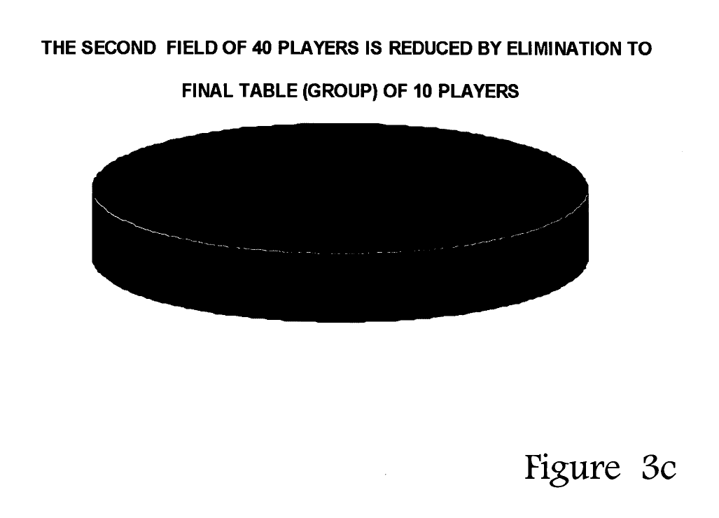

FIGS. 3a-3c illustrate a tournament having 400 players in the original field. The field is initially divided into four groups of 100 players, as shown in FIG. 3a, which can be ten tables of ten players each. The original field of 400 players is reduced by elimination to 40 players, and the last ten players of each group of 100 will share 20 percent of the total prize pool. The remaining field of 40 players is then divided into two groups of 20 players per group, as shown in FIG. 3b. The last ten players of each of the remaining two 20 player groups will share 30 percent of the total prize pool and the top five players from each group advance to the final table. FIG. 2c shows the final table of 10 players resulting from the field of 40 players. All the players at the final table will receive a portion of the remainder of the prize pool in proportion to their final standing and as determined by the organizer of the tournament. Typically, this will be fifty percent of the prize pool.

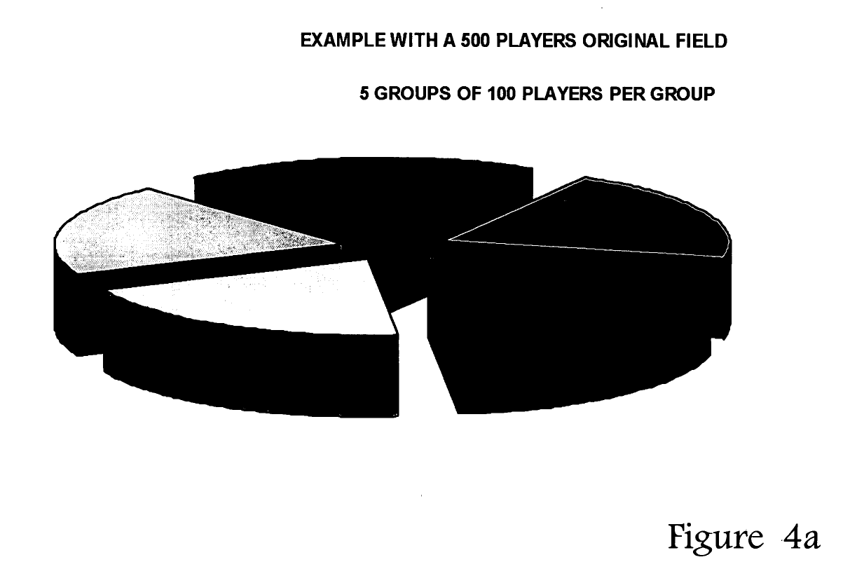

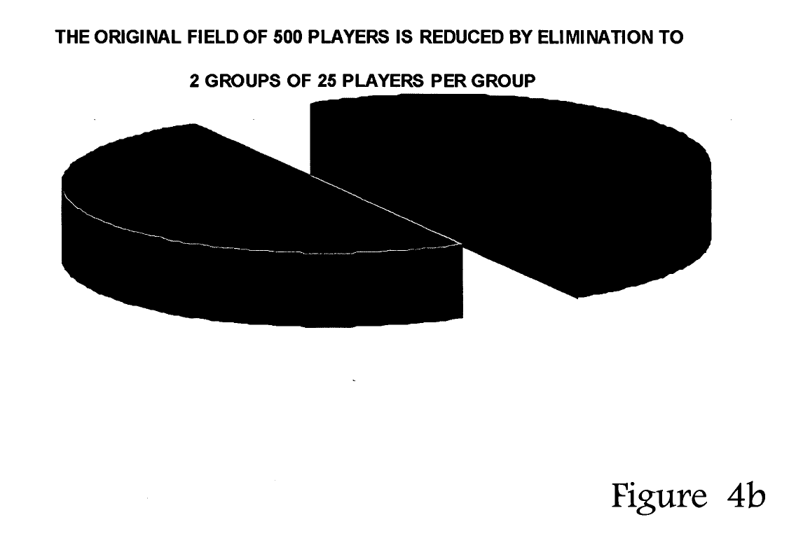

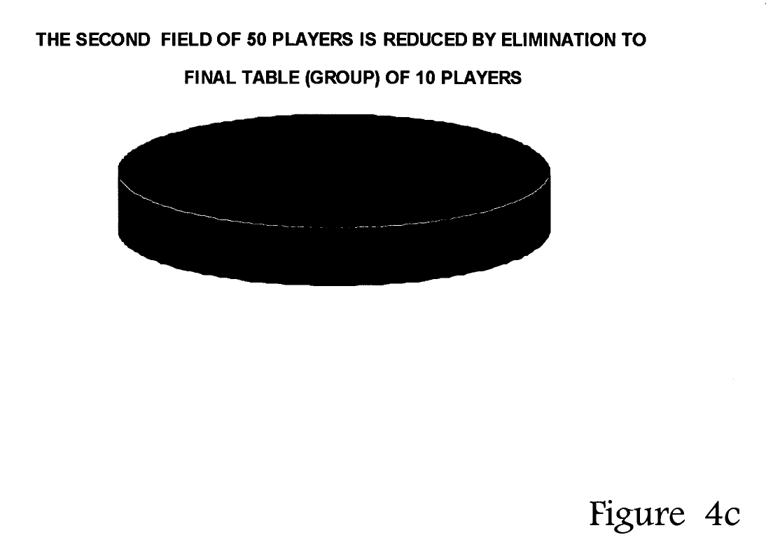

FIGS. 4a-4c illustrate a tournament having 500 players in the original field. The field is initially divided into five groups of 100 players, as shown in FIG. 4a, which can be ten tables of ten players each. The original field of 500 players is reduced by elimination to 50 players, and the last ten players of each group of 100 will share 20 percent of the total prize pool. The remaining field of 50 players is then divided into two groups of 25 players per group, as shown in FIG. 4b. The last ten players of each of the remaining two 25 player groups will share 30 percent of the total prize pool and the top five players from each group advance to the final table. FIG. 4c shows the final table of 10 players resulting from the field of 50 players. All the players at the final table will receive a portion of the remainder of the prize pool in proportion to their final standing and as determined by the organizer of the tournament. Typically, this will be fifty percent of the prize pool.

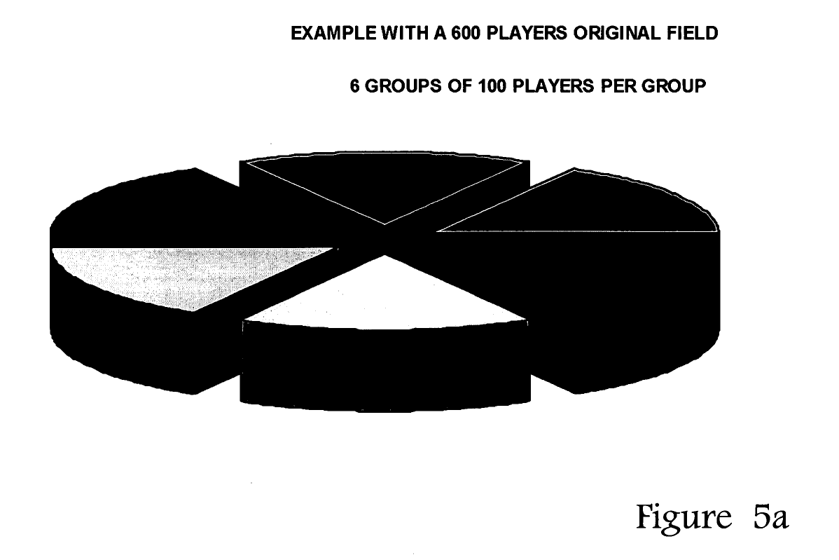

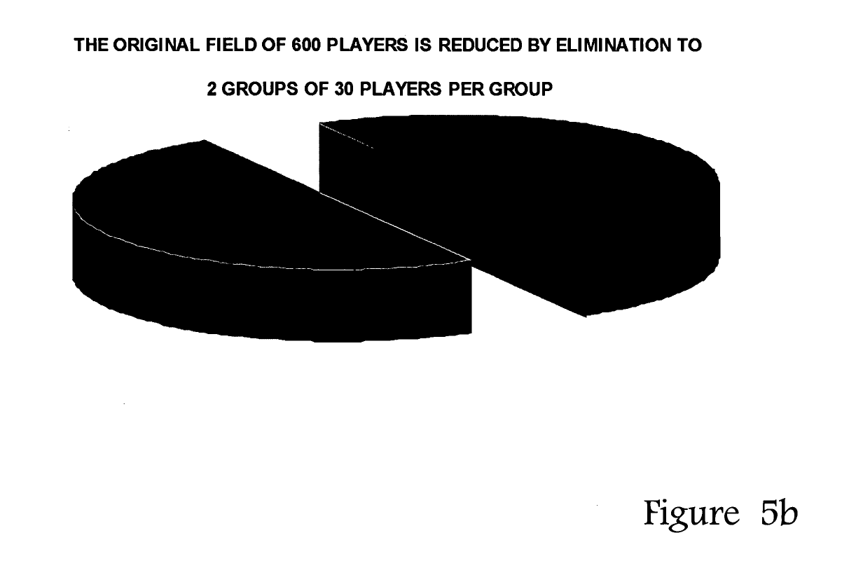

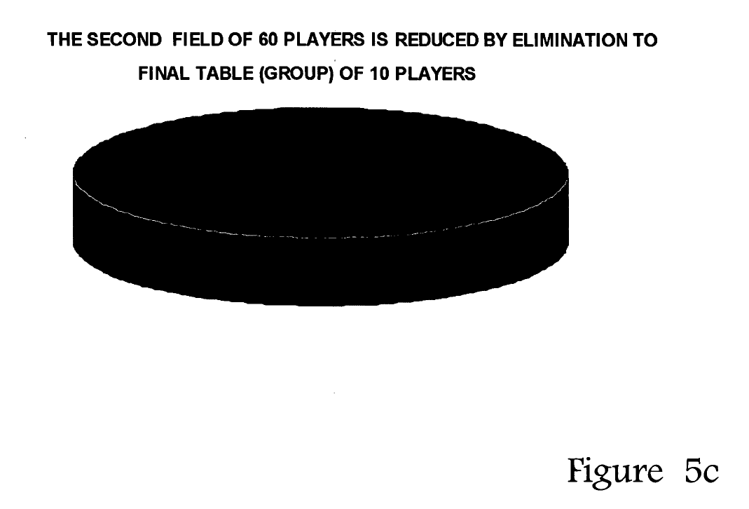

FIGS. 5a-5c illustrate a tournament having 600 players in the original field. The field is initially divided into six groups of 100 players, as shown in FIG. 5a, which can be ten tables of ten players each. The original field of 600 players is reduced by elimination to 60 players, and the last ten players of each group of 100 will share 20 percent of the total prize pool. The remaining field of 60 players is divided into two groups of 30 players per group, as shown in FIG. 5b. The last ten players of each of the remaining two 30 player groups will share 30 percent of the total prize pool and the top five players from each group advance to the final table. FIG. 5c shows the final table of 10 players resulting from the field of 60 players. All the players at the final table will receive a portion of the remainder of the prize pool in proportion to their final standing and as determined by the organizer of the tournament. Typically, this will be fifty percent of the prize pool.

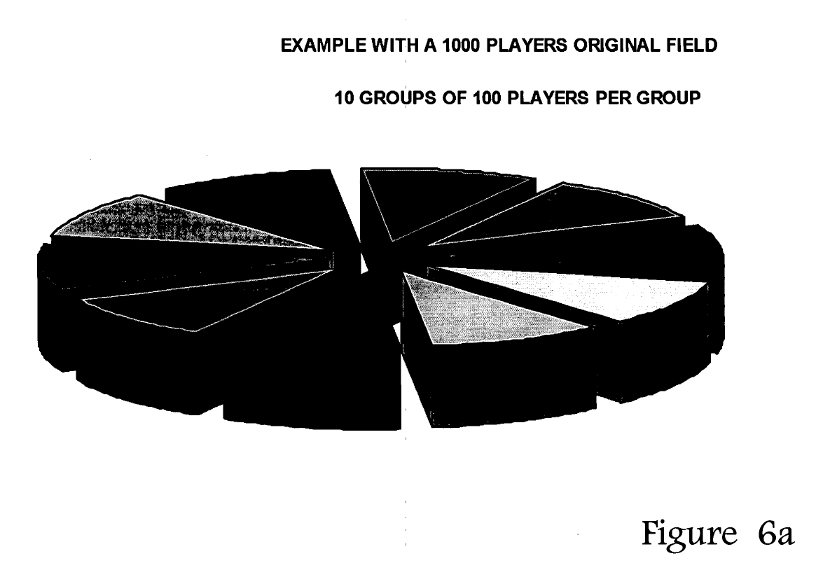

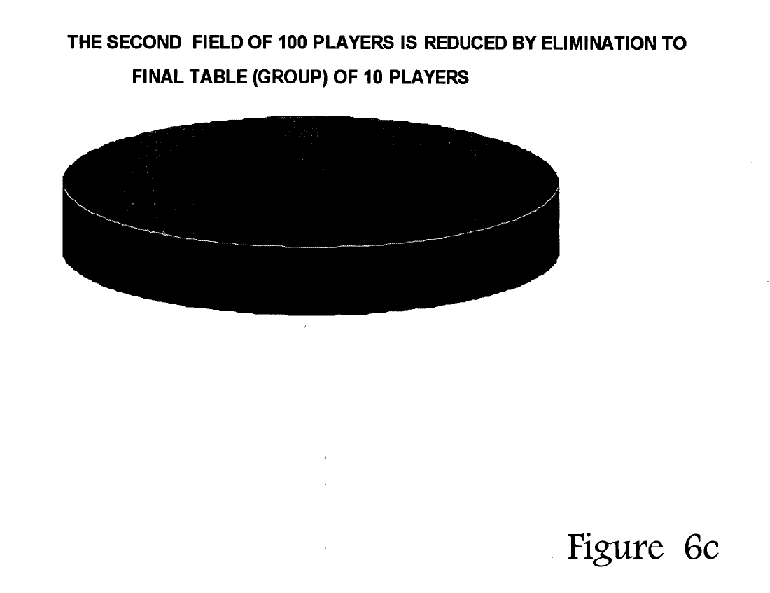

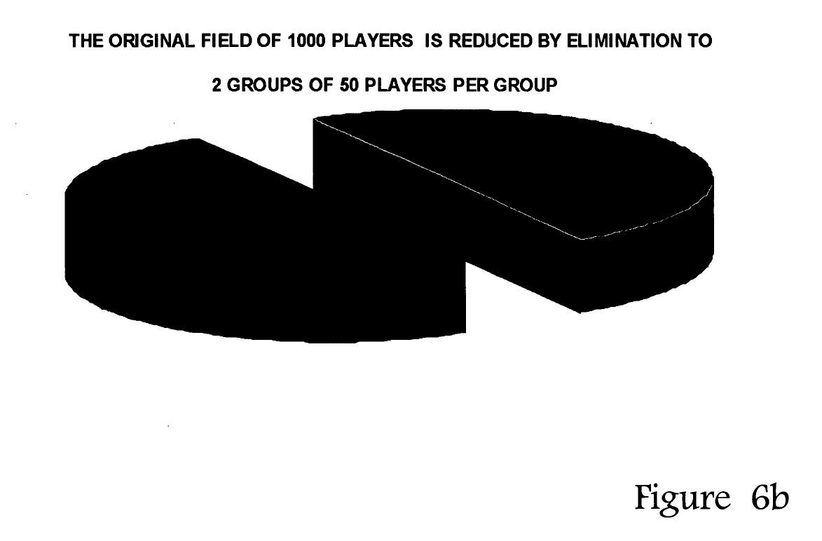

FIGS. 6a-6c illustrate a tournament having 1,000 players in the original field. The field is initially divided into ten groups of 100 players, as shown in FIG. 6a, which can be ten tables of ten players each. The original field of 1,000 players is reduced by elimination to 100 players, and the last ten players of each group of 100 will share 20 percent of the total prize pool. The remaining field of 100 players is divided into two groups of 50 players per group, as shown in FIG. 6b. The last ten players of each of the remaining two 50 player groups will share 30 percent of the total prize pool and the top five players from each group advance to the final table. FIG. 6c shows the final table of 10 players resulting from the field of 50 players. All the players at the final table will receive a portion of the remainder of the prize pool in proportion to their final standing and as determined by the organizer of the tournament. Typically, this will be fifty percent of the prize pool.

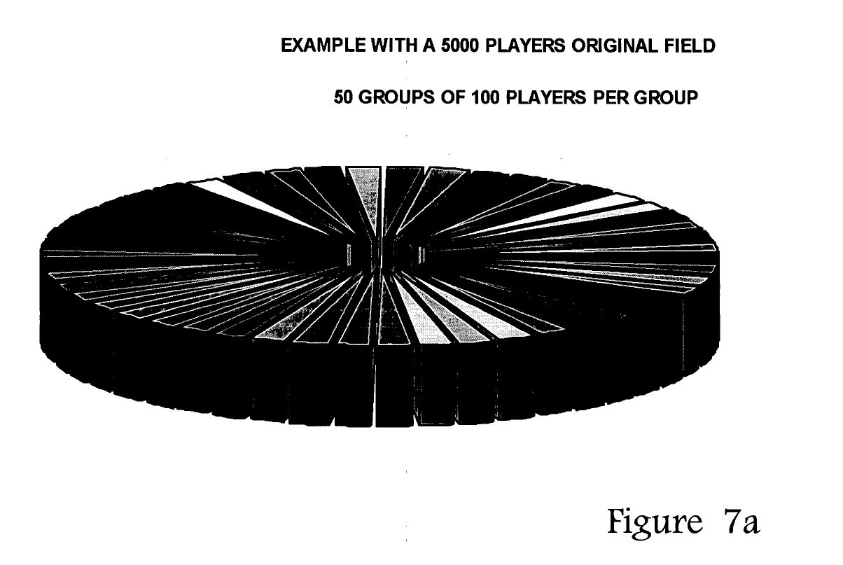

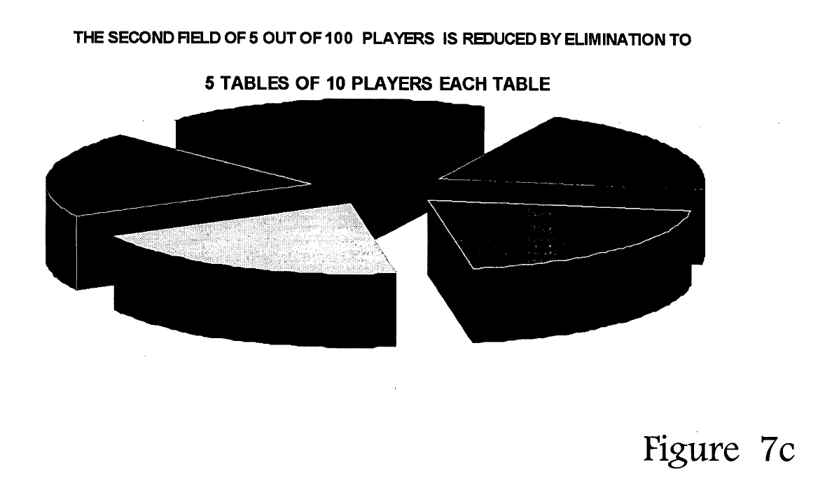

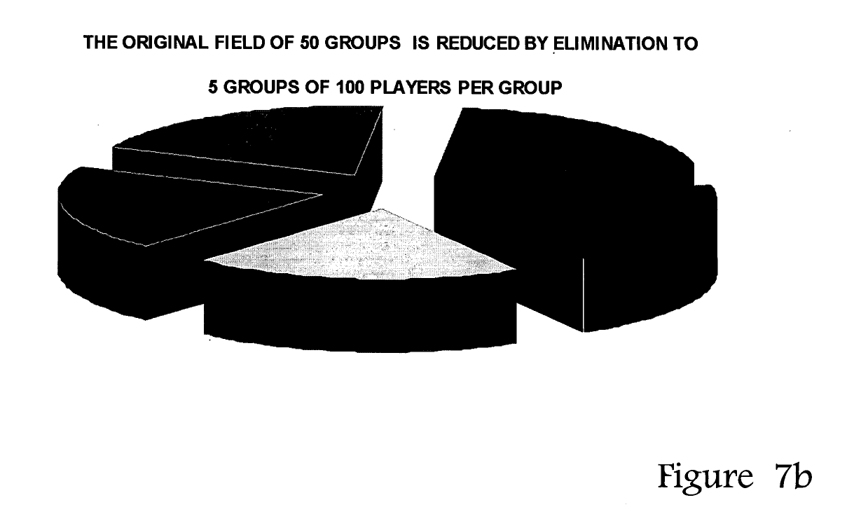

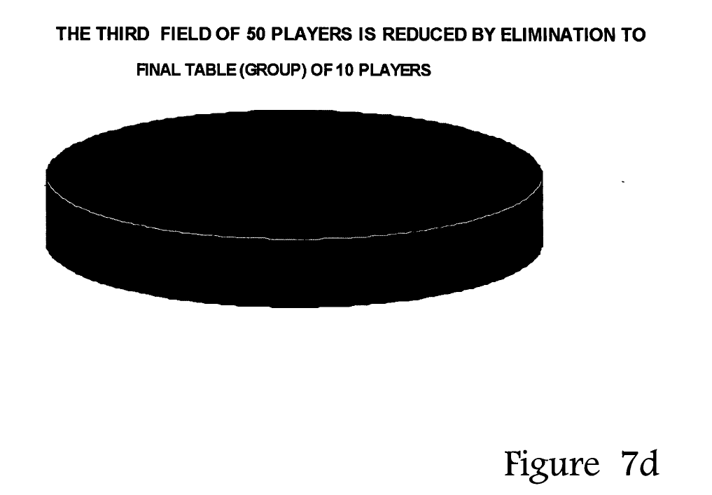

FIGS. 7a-7d illustrate a tournament having 5,000 players in the original field. The field is initially divided into fifty groups of 100 players, as shown in FIG. 7a, which can be ten tables of ten players each. The original field of 5,000 players is reduced by elimination to 500 players, and the last ten players of each group of 100 will share 5 percent of the total prize pool. The remaining field of 500 players is divided into five groups of 100 players per group, as shown in FIG. 7b. The last ten players of each second group of 100 will share 15 percent of the total prize pool. The second group of 500 players is reduced by elimination to 50 players, which is divided into five tables of ten players each, as shown in FIG. 7c. An identified number of players of the remaining five 10 player groups will share 30 percent of the total prize pool and the top players advance to the final table. FIG. 4d shows the final table of 10 players resulting from the final field of 50 players. All the players at the final table will receive a portion of the remainder of the prize pool in proportion to their final standing and as determined by the organizer of the tournament. Typically, this will be fifty percent of the prize pool.

A player is placed in a group by random assignment. Each player should enter the tournament with the same number of chips. Whenever a player advances to the next group, the player will enter into the new group with the chips from the previous round. In an alternate embodiment, the organizers of the tournament may establish a rule that the advancing players begin with an equal amount of chips.

Several examples of groupings of players have been described. Of course, the number of players to be awarded a share of the winnings and the various percentages can be determined by the tournament organizer. Furthermore, the number of players to advance from each group can be determined according to the needs of the tournament. In general, the tournament can be enabled for use in poker tournaments, but can be used for baccarat, blackjack, and other gambling games. Play in each round should be according to accepted standards for the type of game being played.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art could modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

What is claimed is:

1. A method for organizing tournaments, comprising the steps of:
a) establishing a field of ‘N’ players;
b) dividing the field of players into a predetermined number of groups of players, such that each group can be arranged at an equal number of tables having approximately equal number of players per table;
c) determining the number of players to advance to another round;
d) enabling each table of players to play a game in a round of play, until a player is eliminated;
e) continuing to play the game until enough players are eliminated such that the number of players remaining is the number of players determined in step c);
f) repeating steps b) through e), wherein the field of players includes only the advancing players, as necessary, until a final table of players is obtained;
f) enabling the final table to play the game until a final winner is determined.

2. The method of claim 1, further comprising the steps of:
as players advance to another round, paying such players at least a portion of the prize pool.

3. The method of claim 2, wherein the portion of the prize pool increases in percentage in subsequent rounds.

4. The method of claim 1, wherein the game is a gambling game.

5. The method of claim 1, wherein the game is selected from the group consisting of:
poker;
blackjack; and
baccarat.

6. The method of claim 1, wherein the field consists of 200 players divided into two groups of 100 players each, and each group is spread over ten tables of ten players; players are eliminated from each table such that twenty players advance to a second round with such players divided into two groups of ten players.

7. The method of claim 1, wherein the field consists of 360 players divided into four groups of 90 players each and each group is spread over nine tables of ten players; players are eliminated from each table such that thirty-six players advance to a second round with such players divided into two groups of eighteen players.

8. The method of claim 1, wherein the field consists of 400 players divided into four groups of 100 players each and each group is spread over ten tables of ten players; players are eliminated from each table such that forty players advance to a second round with such players divided into two groups of twenty players.

9. The method of claim 1, wherein the field consists of 500 players divided into five groups of 100 players each and each group is spread over ten tables of ten players; players are eliminated from each table such that fifty players advance to a second round with such players divided into two groups of twenty-five players.

10. The method of claim 1, wherein the field consists of 600 players divided into six groups of 100 players each and each group is spread over ten tables of ten players; players are eliminated from each table such that sixty players advance to a second round with such players divided into two groups of thirty players.

11. The method of claim 1, wherein the field consists of 1000 players divided into ten groups of 100 players each and each group is spread over ten tables of ten players; players are eliminated from each table such that 100 players advance to a second round with such players divided into two groups of fifty players.

12. The method of claim 1, wherein the field consists of 5000 players divided into fifty groups of 100 players each and each group is spread over ten tables of ten players; players are eliminated from each table such that 500 players advances to a second round, with said 500 players subdivided into five sub-groups of 100 players and each sub-group is spread over ten tables of ten players; players are eliminated from each table such that fifty players advance to a third round with such players divided into five groups of ten players.

13. The method of claim 1, wherein the field of players is divided randomly.
